(19) United States
(12) Patent Application Publication
(10) Pub. No.: US 2008/0185833 A1
(43) Pub. Date: Aug. 7, 2008

(54) Paper Pad Construction

(76) Inventor: Russell Deen Pollman, El Paso, TX (US)

Correspondence Address: QUICKPATENTS, INC., 32861 CALLE PERFECTO, SUITE A, SAN JUAN CAPISTRANO, CA, 92675, US

(21) Appl. No.: 11/670,658

(22) Filed: Feb. 2, 2007

(51) Int. Cl. B42D 17/00; B42D 5/00

(52) U.S. Cl. 281/44; 281/15.1

(57) ABSTRACT

The present device is an easel pad that comprises a plurality of generally rectangular paper sheets stacked adjacent to each other in a stack, a top-most sheet and a bottom-most sheet sandwiching each other sheet. Each sheet includes a linear detaching perforation extending from a right edge thereof to an opposing left edge thereof that is at a marginal distance from and generally parallel to a top edge of each sheet, such that the marginal distance defines a top margin of each sheet. A backing sheet extends around the top edges of each of the paper sheets and down substantially to the detaching perforation of the top-most sheet. The backing sheet is fastened to each of the plurality of sheets with at least two fastening means fixed proximate the detaching perforation at each of the right and left edges of each paper sheet, creating stress points at the left and right edges of each sheet at the detaching perforation thereof for facilitating the removal of each sheet from the pad by tearing at the perforation. Each sheet further includes a plurality of horizontal and vertical separating perforations or score lines, dividing the sheet into a plurality of generally equally-sized sub-sheets. Preferably each sub-sheet is substantially formed to be a commonly used paper size, such as A4, letter, or legal sized

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to paper pads, and more particularly to an improved easel pad.

### DISCUSSION OF RELATED ART

The common easel pad, basically unchanged since its introduction and illustrated in FIG. 1, serves its purpose well when used for recording information in a meeting environment, such as for jotting down notes or drawings. However, there are significant drawbacks to the conventional easel pad once a given sheet of paper within the pad has been used and needs to be either discarded, stored, transported, or otherwise removed from the easel pad.

Typically when trying to remove such a top-most sheet, the user grasps the sheet at its edge and attempts to pull at a detaching perforation located near the top edge of the sheet. However, the fastening means typically used with conventional pads, namely staples, are not located near the edge of the sheet proximate to the detaching perforation. As such, the stress-point created by such fasteners tends to cause the paper sheet to tear proximate the staple as opposed to along the detaching perforation. To get the tear started at the proper location, name the detaching perforation, the user must typically squeeze the pad adjacent to the detaching perforation with one hand and pull the sheet with the other hand. Once the tear of the detaching perforation has started, simply pulling the sheet downward and to the side continues the tear along the detaching perforation. Thus, conventional easel pads require two-hands to remove a sheet cleaning at its detaching perforation.

Further, once the sheet is removed from the pad, since the sheet is not scored or otherwise sub-dived into sub-sheets, folding of such a sheet results in sub-sheets of non-equal and uncommon sizes. It would be far more convenient if the sheet, once folded, would conform to a common paper size so as to fit easily into envelopes, folders, binders, shredders, or the like. Further, sometimes it is desirable to copy the contents of the sheet for distribution. Large easel pad size sheets do not fit well through a copy machine's paper feeder, a fax machine's scanner, or the like. Thus, it would be convenient for the sheets to be separable into commonly sized sheets for use with such equipment.

Therefore, there is a need for an inexpensive easel pad that sheets that are more easily removed from the pad without tearing inappropriately. Such a needed easel pad would further include sheets that are easy to separate or fold into commonly-sized sub-sheets for use with copy machines, fax machines, binders, envelopes, shredders, and the like. The present invention accomplishes these objectives.

### SUMMARY OF THE INVENTION

The present device is an easel pad that comprises a plurality of generally rectangular paper sheets stacked adjacent to each other in a stack, a top-most sheet and a bottom-most sheet sandwiching each other sheet. Each sheet has substantially the same width and height of each other sheet, such that the stack is uniform. Each sheet includes a linear detaching perforation extending from a right edge thereof to an opposing left edge thereof. The detaching perforation is at a marginal distance from and generally parallel to a top edge of each sheet, such that the marginal distance defines a top margin of each sheet. A backing sheet preferably has substantially the same width of each paper sheet and extends around the top edges of each of the paper sheets, and then down substantially to the detaching perforation of the top-most sheet. The backing sheet is fastened to each of the plurality of sheets with a fastening means.

Preferably each sheet further includes a plurality of horizontal separating perforations extending from its right edge to its left edge, dividing the sheet into a plurality of equal-height portions between its detaching perforation and a bottom edge. Similarly, each sheet further preferably includes a plurality of vertical separating perforations extending from at least its detaching perforation to its bottom edge. Such vertical separating perforations divide the sheet between its left and right edges into a plurality of substantially equal-width portions. As such, each sheet is divided by the horizontal and vertical separating perforations into a plurality of generally euqlly-sized sub-sheets. Preferably each sub-sheet is substantially formed to be a commonly used paper size, such as A4, letter, or legal sized

The fastening means is preferably a penetrating fastener, such as a staple, or the like. A plurality of easel mounting holes may be further formed through the top margin of each sheet. In the case where the fastening means is a penetrating fastener, preferably the easel pad includes at least two such fastening means fixed proximate the detaching perforation at each of the right and left edges of each paper sheet, such that each such fastening means creates a stress point in each sheet for facilitating the removal of each sheet from the pad by tearing at the perforation. Prior art easel pads create a stress-point away from the right or left edges of each sheet, making it difficult to start tearing such a sheet at its detaching perforation.

The present invention is an easel pad that provides more easily-removed sheets. Further, the present device includes sheets that are easy to separate or fold into commonly-sized sub-sheets for use with copy machines, fax machines, binders, envelopes, shredders, and the like. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an illustration of an easel pad of the prior art;

FIG. 2 is an illustration of an easel pad of the present invention;

FIG. 3 is a top plan view of the easel pad of the present invention, illustrating a plurality of sub-sheets formed by a plurality of vertical separating perforations and horizontal separating perforations formed into a stack of paper sheets;

FIG. 4 is a left-side elevational view of the invention, illustrating a backing sheet extending around a top edge of the stack of paper sheets;

FIG. 5 is a top plan view of an embodiment of the invention, illustrating an easel pad in a landscape orientation;

FIG. 6 is a diagram illustrating one of the paper sheets of the invention as being folded before being stored or transported;

FIG. 7 is a diagram illustrating one of the paper sheets of the invention as being separated before being stored or transported; and

FIG. 8 is a diagram illustrating one of the paper sheets of the invention as being separated before being shredded.

### DETAILED DESCRIPTION OF THE PREFERRED EMBODIMENT

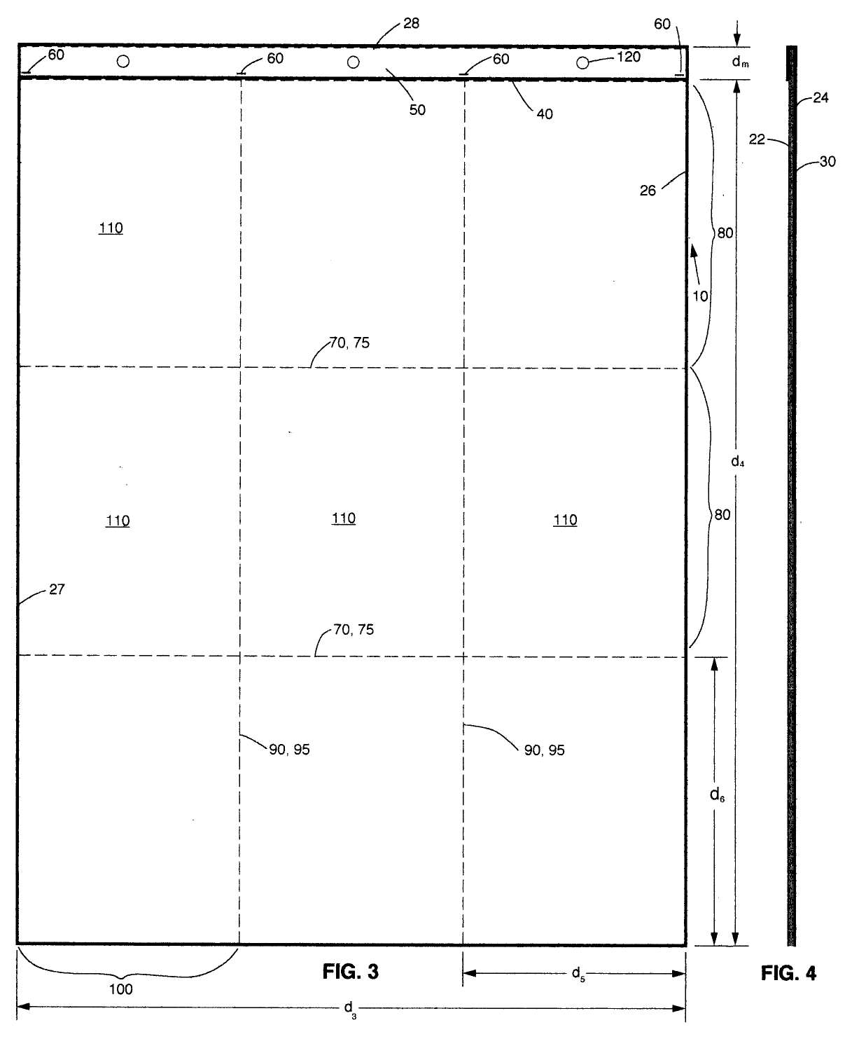

The present invention is an easel pad 10 (FIGS. 3 and 4) that comprises a plurality of generally rectangular paper sheets 20 stacked adjacent to each other in a stack, a top-most sheet 22 and a bottom-most sheet 24 sandwiching each other sheet 20. Each sheet 20 has substantially the same width and height of each other sheet, such that the stack is uniform. Each sheet 20 includes a linear detaching perforation 40 extending from a right edge 26 thereof to an opposing left edge 27 thereof. The detaching perforation 40 is at a marginal distance dm from and generally parallel to a top edge 28 of each sheet 20, such that the marginal distance dm defines a top margin 50 of each sheet 20.

A backing sheet 30 has substantially the same width of each paper sheet 20 and preferably extends around the top edges 28 of each of the paper sheets 20, and then down substantially to the detaching perforation 40 of the top-most sheet 22. The backing sheet 30 is fastened to each of the plurality of sheets 20 with a fastening means 60.

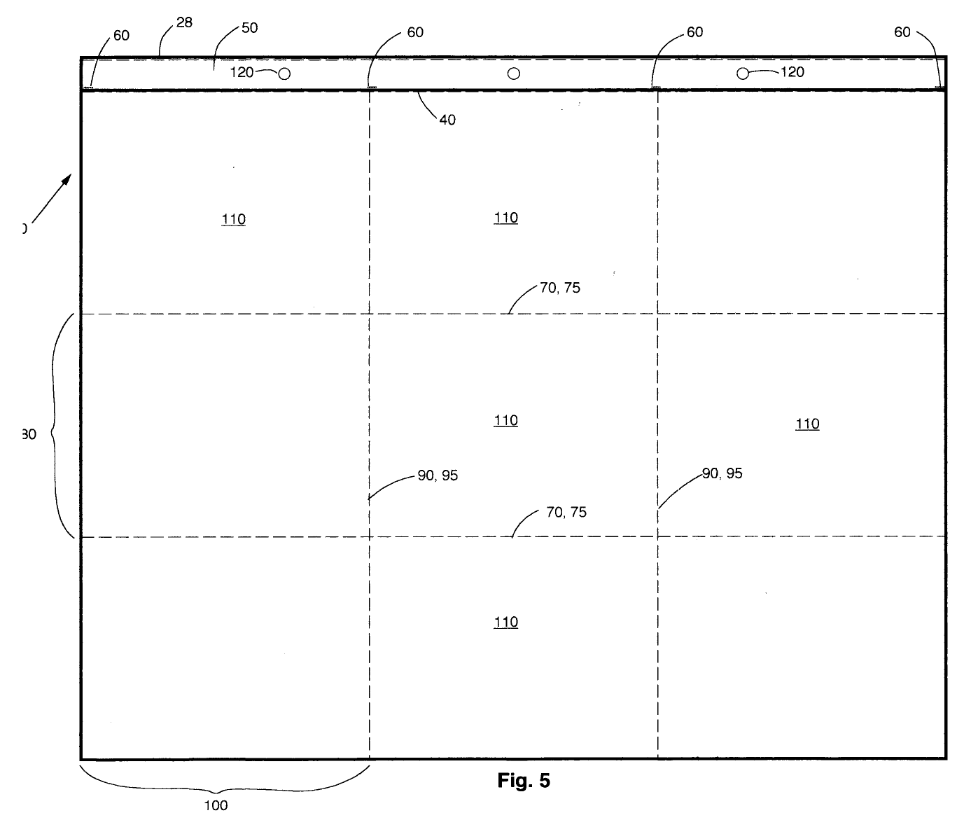

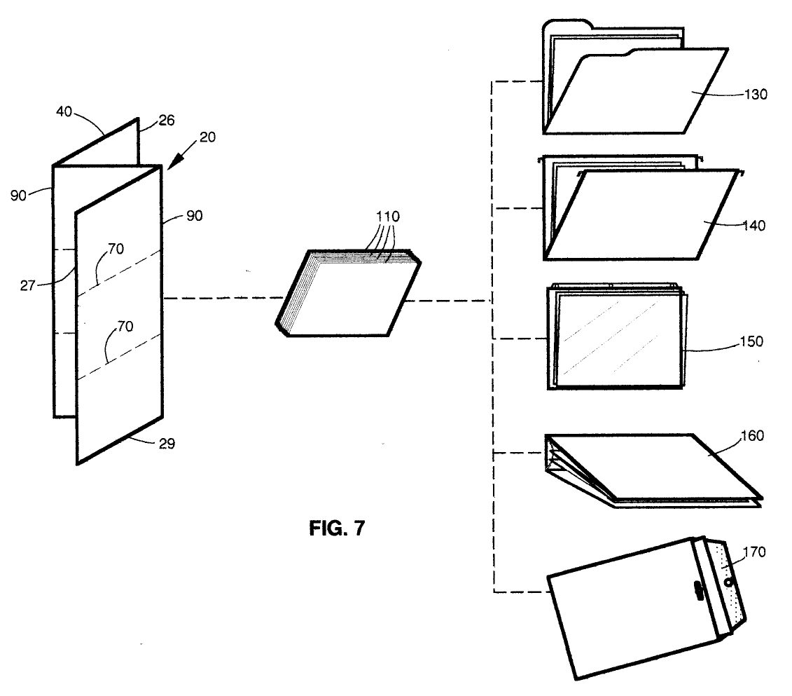

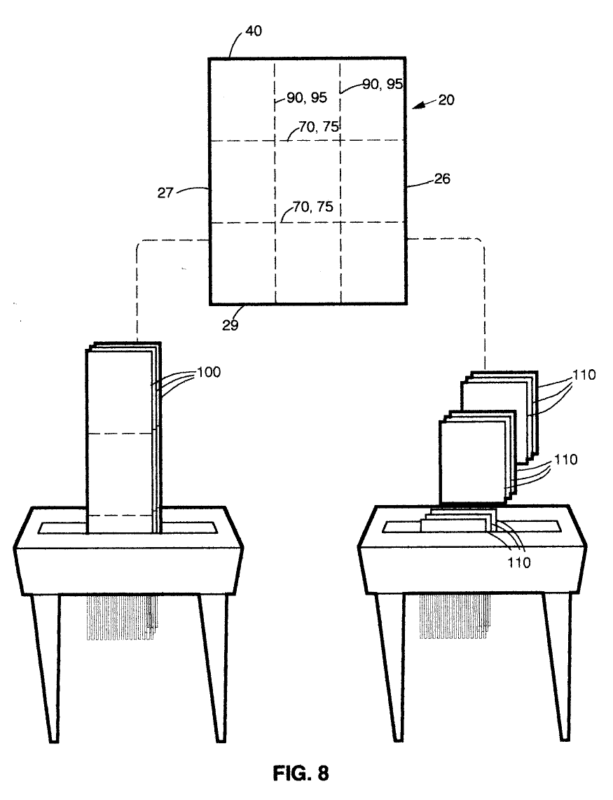

Preferably each sheet 20 further includes a plurality of horizontal separating perforations 70 extending from its right edge 26 to its left edge 27, dividing the sheet 20 into a plurality of equal-height portions 80 between its detaching perforation 40 and a bottom edge 29 thereof (FIGS. 3 and 5). Similarly, each sheet 20 further preferably includes a plurality of vertical separating perforations 90 extending from at least its detaching perforation 40 to its bottom edge 29. Such vertical separating perforations 90 divide the sheet 20 between its left and right edges 26,27 into a plurality of substantially equal-width portions 100. As such, each sheet 20 is divided by the horizontal and vertical separating perforations 70,90 into a plurality of generally euqlly-sized sub-sheets 110 (FIG. 7).

Preferably each sub-sheet 110 is substantially formed to be a commonly used paper size, such as A4 sized, namely 210 mm in one dimension by 297 mm in another dimension; letter sized, namely 8.5 inches in one dimension by 11 inches in another dimension; legal sized, namely 8.5 inches in one dimension by 14 inches in another dimension; or the like. In the preferred mode of the invention, the plurality of horizontal separating perforations 70 is exactly two, and the plurality of vertical separating perforations 90 is exactly two, resulting in nine sub-sheets 110 (FIGS. 3 and 5).

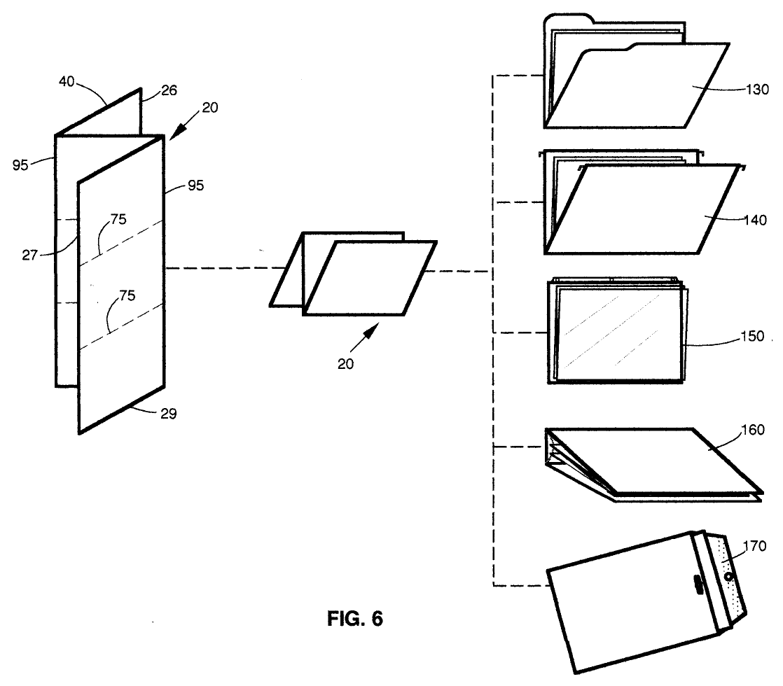

In an alternate embodiment of the invention, illustrated in FIG. 6, the horizontal separating perforations 70 and the vertical separating perforations 90 are replaced with horizontally-scored folding lines 75 and vertically-scored folding lines 95, respectively.

As such, the sub-sheets 110 may be defined by such folding lines 75,95, but not separated from each other sub-sheet 110. As such, each sheet 20 may be folded down to a stack of attached, commonly-sized paper sub-sheets 110, and stored, transported, or otherwise used. In one embodiment, wherein the easel pad 10 and each sheet 20 is of a commonly used size for easel pads in general, each sheet 20 includes two horizontal and two vertical separating perforations 70,90, resulting in nine sub-sheets 110, with the center sub-sheet 110 being substantially letter sized and each other sub-sheet being substantially 8.44 inches in one dimension by 10.94 inches in another dimension.

The fastening means 60 is preferably a penetrating fastener 60, such as a staple, or the like (FIG. 2). However, the fastening means 60 may be a rivet (not shown), a strong adhesive, a weak adhesive (such as found in 3M's Post-It Note® products), or other suitable fastening means 60 as is known or will become known in the art. A plurality of easel mounting holes 120 may be further formed through the top margin 50 of each sheet 20 (FIG. 2).

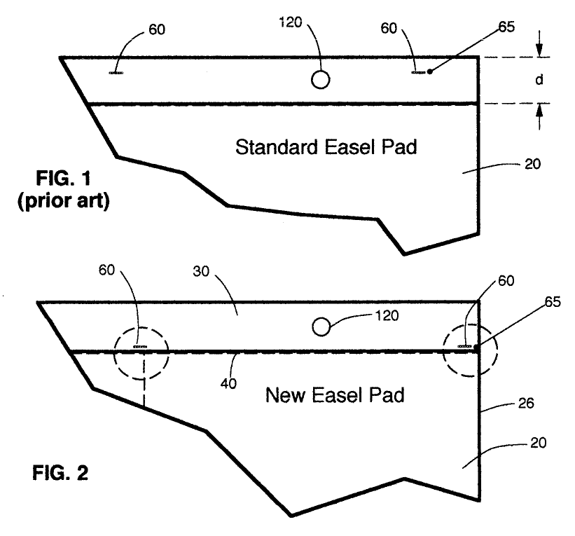

In the case where the fastening means 60 is a penetrating fastener 60, preferably the easel pad 10 includes at least two such fastening means 60 fixed proximate the detaching perforation 40 at each of the right and left edges 26,27 of each paper sheet 20, such that each such fastening means 60 creates a stress point 65 in each sheet 20 for facilitating the removal of each sheet 20 from the pad 10 by tearing at the perforation 40. Prior art easel pads, illustrated in FIG. 1, create a stress-point 65 away from the right or left edges 26,27 of each sheet, making it difficult to start tearing such a sheet 20 at its detaching perforation 40.

While a particular form of the invention has been illustrated and described, it will be apparent that various modifications can be made without departing from the spirit and scope of the invention. For example, paper sheets 20 having various numbers and sizes of sub-sheets 110 may be devised, and the dimensions of such sub-sheets and the overall paper sheets 20 may be modified as appropriate for any given application. Accordingly, it is not intended that the invention be limited, except as by the appended claims.

What is claimed is:

1. An easel pad comprising:
a plurality of generally rectangular paper sheets stacked adjacent to each other, a top-most sheet and a bottom-most sheet sandwiching each other sheet, each sheet having substantially the same width and height of each other sheet, each sheet including a linear detaching perforation extending from a right edge thereof to an opposing left edge thereof at a marginal distance from and generally parallel to a top edge thereof, the marginal distance defining a top margin of each sheet, each sheet fastened to each next adjacent sheet with a fastening means.

2. The easel pad of claim 1 further including a backing sheet having substantially the same width of each paper sheet, covering substantially the entire bottom-most sheet, and extending around the top edges of each of the paper sheets and down substantially to the detaching perforation of the top-most sheet, the backing sheet fastened to each of the plurality of sheets with the fastening means.

3. The easel pad of claim 1 wherein each sheet further includes a plurality of horizontal separating perforations extending from its right edge to its left edge, each horizontal separating perforation dividing the sheet, between its detaching perforation and a bottom edge thereof, into a plurality of substantially equal-height portions.

4. The easel pad of claim 1 wherein each sheet further includes a plurality of vertical separating perforations extending from at least its detaching perforation to its bottom edge, each vertical separating perforation dividing the sheet, between its left edge and its right edge, into a plurality of substantially equal-width portions.

5. The easel pad of claim 1 wherein each sheet further includes a plurality of horizontal separating perforations extending from its right edge to its left edge, each horizontal separating perforation dividing the sheet, between its detaching perforation and a bottom edge thereof, into a plurality of substantially equal-height portions; and wherein each sheet further includes a plurality of vertical separating perforations extending from at least its detaching perforation to its bottom edge, each vertical separating perforation dividing the sheet, between its left edge and its right edge, into a plurality of substantially equal-width portions; whereby each sheet is divided by the horizontal and vertical separating perforations into a plurality of generally equally-sized sub-sheets.

6. The easel pad of claim 5 wherein each sub-sheet is substantially A4 sized, namely 210 mm in one dimension by 297 mm in another dimension.

7. The easel pad of claim 5 wherein each sub-sheet is substantially letter sized, namely 8.5 inches in one dimension by 11 inches in another dimension.

8. The easel pad of claim 5 wherein each sub-sheet is substantially legal sized, namely 8.5 inches in one dimension by 14 inches in another dimension.

9. The easel pad of claim 5 wherein each sheet includes two horizontal and two vertical separating perforations resulting in nine substantially equally-sized sub sheets.

10. The easel pad of claim 5 wherein each sheet includes two horizontal and two vertical separating perforations resulting in nine sub sheets, the center sub-sheet being substantially letter sized, namely 8.5 inches in one dimension by 11 inches in another dimension, and each other sub-sheet being substantially 8.44 inches in one dimension by 10.94 inches in another dimension.

11. The easel pad of claim 1 wherein each sheet further includes a plurality of horizontally-scored folding lines extending from its right edge to its left edge, each horizontally-scored folding line dividing the sheet, between its detaching perforation and a bottom edge thereof, into a plurality of substantially equal-height portions.

12. The easel pad of claim 1 wherein each sheet further includes a plurality of vertically-scored folding lines extending from at least its detaching perforation to its bottom edge, each vertically-scored folding line dividing the sheet, between its left edge and its right edge, into a plurality of substantially equal-width portions.

13. The easel pad of claim 1 wherein each sheet further includes a plurality of horizontally-scored folding lines extending from its right edge to its left edge, each horizontally-scored folding line dividing the sheet, between its detaching perforation and a bottom edge thereof, into a plurality of substantially equal-height portions; and wherein each sheet further includes a plurality of vertically-scored folding lines extending from at least its detaching perforation to its bottom edge, each vertically-scored folding line dividing the sheet, between its left edge and its right edge, into a plurality of substantially equal-width portions; whereby each sheet is divided by the horizontally and vertically-scored folding lines into a plurality of generally equally-sized sub-sheets.

14. The easel pad of claim 13 wherein each sub-sheet is substantially A4 sized, namely 210 mm in one dimension by 297 mm in another dimension.

15. The easel pad of claim 13 wherein each sub-sheet is substantially letter sized, namely 8.5 inches in one dimension by 11 inches in another dimension.

16. The easel pad of claim 13 wherein each sub-sheet is substantially legal sized, namely 8.5 inches in one dimension by 14 inches in another dimension.

17. The easel pad of claim 13 wherein each sheet includes two horizontal and two vertical separating perforations resulting in nine substantially equally-sized sub sheets.

18. The easel pad of claim 13 wherein each sheet includes two horizontal and two vertical separating perforations resulting in nine sub sheets, the center sub-sheet being substantially letter sized, namely 8.5 inches in one dimension by 11 inches in another dimension, and each other sub-sheet being substantially 8.44 inches in one dimension by 10.94 inches in another dimension.

19. The easel pad of claim 1 wherein at least two fastening means are fixed proximate the detaching perforation at each of the right and left edges of each paper sheet, whereby each fastening means proximate the detaching perforation of each of the right and left edges of each paper sheet create a stress point in each sheet for facilitating removal of each sheet from the pad by tearing at the perforation.

20. The easel pad of claim 1 wherein a plurality of easel mounting holes are formed through the top margin of each sheet.
